(19) United States
(12) Patent Application Publication
(10) Pub. No.: US 2025/0075982 A1
(43) Pub. Date: Mar. 6, 2025

(54) REFORMING EXCHANGER TUBESHEET AND SHELL FLANGE DESIGN

(71) Applicants: Xiang Yang Zhang, Katy, TX (US); Paulus Harijadi Christiono, Sugar Land, TX (US)

(72) Inventors: Xiang Yang Zhang, Katy, TX (US); Paulus Harijadi Christiono, Sugar Land, TX (US)

(73) Assignee: KELLOGG BROWN & ROOT LLC, Houston, TX (US)

(21) Appl. No.: 18/819,384

(22) Filed: Aug. 29, 2024

Related U.S. Application Data
(60) Provisional application No. 63/579,740, filed on Aug. 30, 2023.

(51) Int. Cl. F28D 7/16; B01J 19/00; B01J 19/24; C01B 3/34; F28F 9/00

(52) U.S. Cl. CPC F28D 7/16; B01J 19/0013; B01J 19/2425; C01B 3/34; F28F 9/005; B01J 2219/00092; B01J 2219/00155; C01B 2203/0233; C01B 2203/0244; F28F 2230/00; F28F 2275/20

(57) ABSTRACT

A syngas reforming exchanger reactor design is described. The reforming exchanger has a head, a shell, and a tubesheet secured a tube bundle. The tubesheet is bolted to the shell, after which the head is bolted to the shell. A seal is configured between the tubesheet and components of the shell. Another seal is configured between components of the head and the tubesheet. In the reformer exchanger design, those seals are maintained under bolted pressure via the bolting of both the tubesheet and the head to the shell. This design improves the integrity of sealing, thereby preventing escape of hot reformed gases from the reformer exchanger reactor during operation.

This application claims priority to U.S. Provisional Patent Application having Ser. No. 63/579,740 filed on Aug. 30, 2023 which is incorporated by reference herein.

### FIELD OF THE INVENTION

This disclosure relates to reforming reactor heat exchangers for syngas production. More specifically, the disclosure describes a reforming reactor heat exchangers with an improved exchanger tube bundle top tubesheet construction that is bolted into an improved shell flange design to eliminate hot gas leakage.

### INTRODUCTION

Steam reforming of a hydrocarbon to manufacture syngas is a process in which the hydrocarbon and an oxygen source are supplied to an autothermal reformer. The combustion reaction is exothermic and supplies the heat needed for the catalytic reforming reaction that occurs in the autothermal reformer, which is endothermic, to produce a relatively hot reformed gas. The hot gas from the autothermal reformer is then used as a heat source in the reforming exchanger, which is operated as an endothermic catalytic steam reforming zone. In the reforming exchanger, a feed comprising a mixture of steam and hydrocarbon is passed through catalyst-filled tubes. The outlet ends of the tubes discharge the endothermically reformed gas near the shell side inlet where it mixes with the hot gas from the autothermal reformer. The hot gas mixture is then passed countercurrent across the outside of the tubes in indirect heat exchange to supply the heat necessary for the endothermic reforming reaction to occur.

Reforming exchangers are in use commercially and are available, for example, from Kellogg, Brown, & Root LLC (“KBR”) under the trade designation KRES. Various improvements to the reforming exchanger design have been made and are disclosed in, for example, U.S. Pat. Nos. 5,362,454; 6,855,272; 7,635,456; and 7,550,215.

### SUMMARY

Disclosed herein is a reforming exchanger reactor. In some examples, the reforming exchanger reactor comprises a shell comprising a shell side fluid inlet configured to receive hot reformed gas; a head comprising a tube side fluid inlet configured to receive a mixed gas feed; a tube bundle comprising a plurality of tubes, wherein each of the tubes comprises: an inlet end secured to a tubesheet configured to receive the mixed gas feed from the head; and an outlet end adjacent to the shell side fluid inlet and configured to discharge catalytically reformed gas into the hot reformed gas to form a gas mixture; and a shell side fluid outlet fluidly isolated from the tube side fluid inlet by the tube sheet and configured for discharging the gas mixture. In some examples, the tube sheet is bolted to the shell, thereby disposing the tubes within the shell. In some examples, the tubesheet is bolted directly to an interior of the shell. In some examples, the head comprises a head flange, the shell comprises a shell flange, and the head flange is configured to bolt to the shell flange, thereby securing the head to the shell. In some examples, the shell comprises a shell refractory lining affixed to an interior surface of the shell and comprising one or more layers of refractory materials. In some examples, the reforming exchanger reactor further comprises a first seal configured between a portion of the shell flange and a portion of the tubesheet. In some examples, the tubesheet comprises a tubesheet refractory lining configured on a shell side surface of the tubesheet, and wherein the first seal is configured between the tubesheet refractory lining and the shell refractory lining. In some examples, the tubesheet comprises a tubesheet refractory lining configured on a shell side surface of the tubesheet, the shell comprises a shell refractory latch affixed to an interior surface of the shell flange, and the first seal is configured between the tubesheet refractory lining and the shell latch. In some examples, the first seal is maintained between the tubesheet and the shell flange under bolted pressure by the bolting of the tubesheet to the shell. In some examples, the head comprises a head refractory lining affixed to an interior surface of the head and the head refractory lining comprises one or more layers of refractory materials. In some examples, the reforming exchanger further comprises a second seal configured between a portion of the head and the tubesheet. In some examples, the second seal is configured between the head refractory lining and the tubesheet. In some examples, the head comprises a head refractory latch affixed to an interior surface of the head, and the second seal is configured between the head refractory latch and the tubesheet. In some examples, the second seal is maintained between the tubesheet and the head under bolted pressure by the bolting of the head flange to the shell flange.

Also disclosed here is a method of assembling a reforming exchanger reactor, wherein the reforming exchanger reactor comprises a shell configured to receive hot reformed gas, a head comprising a tube side fluid inlet configured to receive a mixed gas feed, and a tube bundle comprising a tubesheet and plurality of tubes. In some examples, the method comprises: disposing a first seal upon a first portion of the shell; bolting the tubesheet to the shell so that the plurality of tubes are within the shell and the first seal is secured between the tubesheet and the first portion of the shell; disposing a second seal on a top portion of the tubesheet; and bolting the head to the shell so that the second seal is secured between a portion of the head and the tubesheet. In some examples, the first portion of the shell comprises a shell refractory latch affixed to an interior surface of the shell. In some examples, the tubesheet comprises a tubesheet refractory lining configured on a shell side surface of the tubesheet, and the first seal is secured between the tubesheet refractory lining and the shell refractory latch. In some examples, the shell comprises a shell flange and the head comprises a head flange, and bolting the head to the shell comprises bolting the shell flange to the head flange. In some examples, the head comprises a head refractory latch affixed to an interior surface of the head and wherein the second seal is secured between the head refractory latch and a top surface of the tubesheet.

### BRIEF DESCRIPTION OF THE DRAWINGS

FIG. 1 shows a cross-sectional side elevation view of an embodiment of a reforming exchanger.

FIG. 2 shows a cross-sectional view of the embodiment of the reforming exchanger shown in FIG. 1 as seen along the lines 2-2 showing the discharge flow annulus.

FIG. 3 shows a cross-sectional view of the embodiment of the reforming exchanger shown in FIG. 1 as seen along the lines 3-3 showing a lattice support assembly.

FIG. 4 shows a magnified cross-sectional side elevation view of a portion the embodiment of the reforming exchanger shown in FIG. 1 focusing on the components contained within the dashed square labeled 4 in FIG. 1.

### DESCRIPTION

Aspects of this disclosure relate to embodiments of a reforming exchanger design using a shell-side flow arrangement that provides a longitudinal countercurrent flow through a tube bundle. Embodiments of the reforming exchanger comprise a tube side head (also referred to herein as a channel dome), a shell, and a tube bundle. One or more heat resistant refractory linings may be affixed to the interior surface of the shell. The head of the reforming reactor may include one or more refractory linings. A longitudinal shell side flow arrangement may result in efficient heat transfer with a low pressure drop in the shell side fluid. The reforming exchanger may have relatively high and low temperature ends. A shell side fluid inlet may be provided in the shell adjacent to the high temperature end of the reforming exchanger. The shell side fluid inlet may be configured to receive a hot gas feed. In some examples, the hot gas feed may be a hot reformed gas, for example, from an upstream reformer, such as an auto-thermal reformer (ATF). A tube side fluid inlet may be provided in the tube side head adjacent to the low temperature end of the reforming exchanger. The tube side fluid inlet may allow a mixed gas feed to enter the reforming exchanger. In some examples, the mixed gas feed may contain steam and one or more hydrocarbons, such as natural gas. A shell side fluid outlet may be configured in the shell such that it is isolated from the tube side fluid inlet by a tubesheet. The shell side fluid outlet may be adjacent to the low temperature end of the shell. The shell side fluid outlet allows an exchanger product gas mixture to be discharged from the reforming exchanger. In some examples, the reforming exchanger product gas mixture contains syngas.

The tube bundle may include one or more tubes (for example, thousands of tubes) and one or more longitudinally spaced transverse ring baffles. The tubes may include an inlet end secured to the tubesheet, and an outlet end located adjacent to the shell side fluid inlet. During operation, the mixed gas feed from the tube side head enters the tubes and passes through the tubes. The tubes may contain catalyst-bearing monolithic structures for converting the gas feed mixture to reformed gas. The catalytically reformed gas exits the tubes, where it is mixed with the hot reformed gas that is provided via the shell side fluid inlet. The mixture of the hot reformed gas and catalytically reformed gas from the tubes follows a longitudinal shell side flow and exits the reforming exchanger via the shell side fluid outlet as the reforming exchanger product gas mixture. More details about process conditions, catalysts, and other details of the general process can be found in U.S. Pat. Nos. 5,011,625; 5,122,299; 5,362,454; 6,855,272; 7,138,001; and 7,220,505, which are fully incorporated by reference herein.

The tubesheet of the disclosed reforming exchanger may be configured to attach (typically via bolting) to the shell flange proximate to the discharge annulus. According to some embodiments, the shell may include a shell flange, to which the tubesheet and the tube side head can be attached. A seal (referred to herein as a “middle seal”) can be disposed between the tubesheet and the shell flange (specifically, between the tubesheet and the internal refractory lining(s) of the shell). The middle seal may be maintained under bolted pressure between the tubesheet and the flange of the shell. Once the tubesheet is attached to the shell, the tube-side head may be attached to the shell flange, typically by bolting a flange upon the head (referred to herein as a “head flange”) to the shell flange of the shell. A seal (referred to herein as a “top seal”) can be disposed between the refractory lining(s) of the head and the tubesheet. During operation, the top seal and the middle seal may both be maintained under bolted pressure, which serves to maintain sealing integrity and to prevent the escape of hot gases from the reforming reactor. The disclosed configuration may be effective for reducing or eliminating potential hot reformer gas leaks, which may create hot spots. The disclosed designs may reduce or eliminate the “hanging tubesheet skirt” design of existing systems (see, e.g., U.S. Pat. No. 7,635,456, which is hereby incorporated by reference).

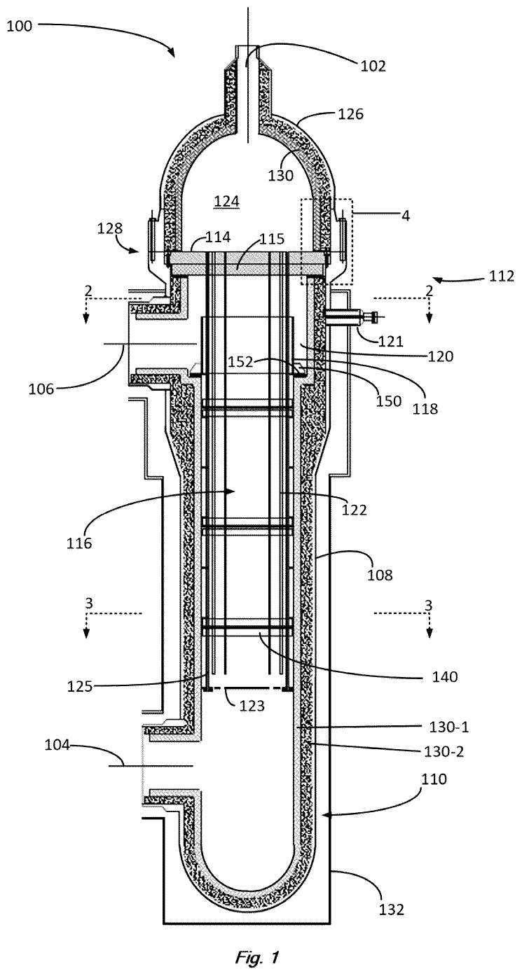

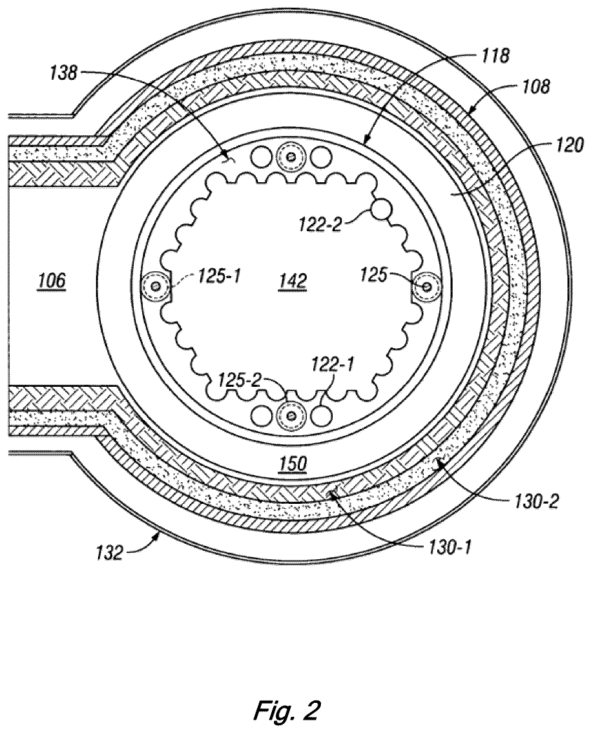

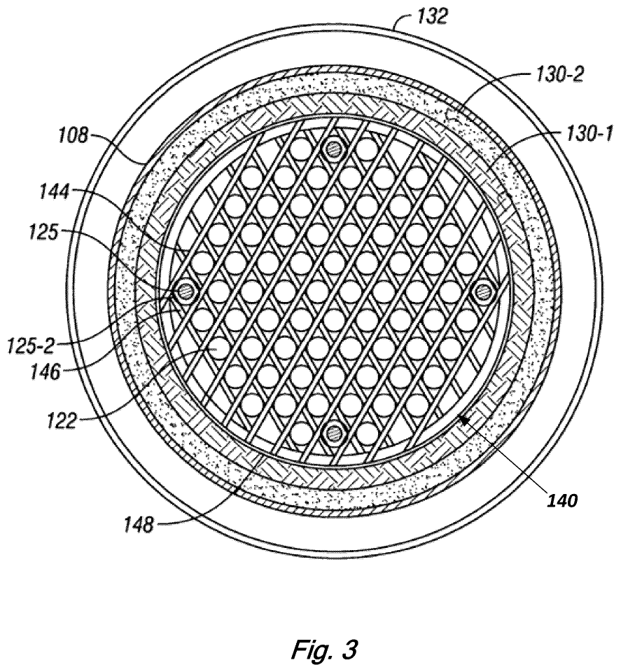

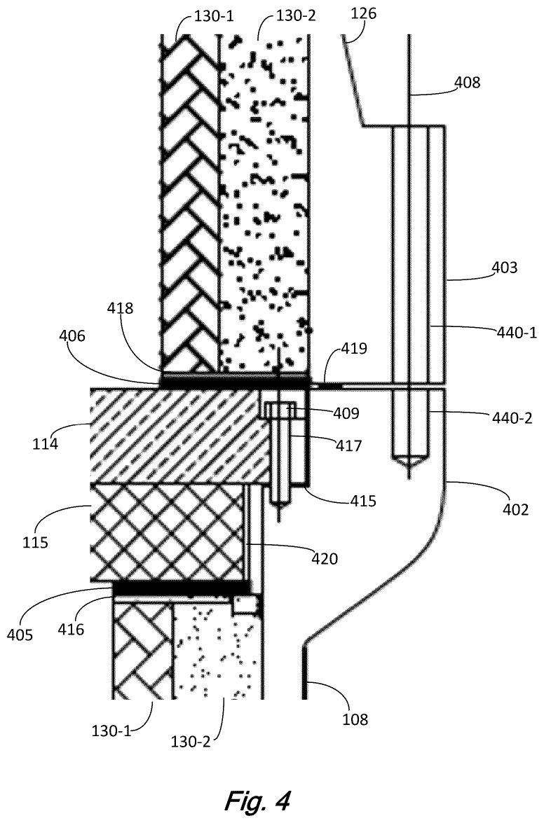

FIGS. 1-4 illustrate an example of a reforming exchanger 100 as disclosed herein. FIG. 1 depicts cross-sectional side elevation of an embodiment of a reforming reactor. FIG. 2 depicts a cross-sectional view of the embodiment of a reforming reactor as shown in FIG. 1 as seen along the lines 2-2 showing the discharge flow annulus. FIG. 3 depicts a cross-sectional view of the embodiment of a reforming reactor as shown in FIG. 1 as seen along the lines 3-3 showing a lattice support assembly. FIG. 4 shows a magnified view of the portion of the reforming reactor indicated by the dashed square 4.

The illustrated reforming exchanger 100 may include a tube side fluid inlet 102, a shell side fluid inlet 104, and a shell side fluid outlet 106 in an shell 108. The reforming exchanger 100 may include respective relatively high and low temperature ends 110 and 112. In an example, the low temperature end can vary from approximately 400° C. to approximately 650° C. (752° F. and 1202° F.) and the high temperature end can vary from approximately 650° C. to approximately 1050° C. (1202° F. and 1922° F.). As used herein, the term “longitudinal” refers to the direction corresponding to the length of the reforming exchanger 100 or generally parallel to the longitudinal axis, whereas “transverse” means transverse with respect to the longitudinal axis unless otherwise indicated.

The shell side fluid inlet 104 may be adjacent to the high temperature end 110 for receiving a hot gas feed. The shell side fluid outlet 106 may be adjacent to the low temperature end 112 for discharging cooled gas from the reforming exchanger 100. The tube side fluid inlet 102 may be adjacent to the low temperature end 112 for receiving a feed mixture of hydrocarbon and steam. The tube side fluid inlet 102 may be fluidly isolated from the shell side fluid outlet 106 by tubesheet 114 from which tube bundle 116 may be supported. The tubesheet 114 may include a tubesheet refractory material 115 disposed on the shell side portion of the tubesheet. The terms “upper” and “lower” may be used for convenience to correspond to the directions toward the tube-side inlet 102/shell-side outlet 106/low temperature end 112 and toward the shell-side inlet 104/high temperature end 110, respectively, although there is no requirement for such a vertical orientation of the exchanger 100.

In examples, a flow sleeve 118 may be disposed about the tube bundle 116 adjacent to the shell side fluid outlet 106. A discharge annulus 120 may be provided between an outer surface of the imperforate flow sleeve 118 and an enlarged diameter region of the shell 108. The flow sleeve 118 may have an open end spaced from the tubesheet 114, and may be sealed at an opposite end adjacent to a base of the discharge annulus 120. The reforming exchanger may be configured with a thermocouple well 121 configured to provide a temperature sensor for monitoring the temperature of gases within the discharge annulus.

In operation, relatively cool reactant feed fluid (for example, fluid ranging from about 480 to about 760° C.) may enter inlet 102. The reactant feed may flow downward through tubesheet 114 and the tube bundle 116. The tube bundle 116 may include a plurality (in some embodiments several hundred up to a thousand or more) of catalyst-filled tubes 122 in which the reactants are catalytically reacted. Although the drawing shows only a few tubes 122 for clarity fewer or more tubes 122 may be present. The reacted fluid may leave from the lower end of each tube 122. A heating fluid (for example, effluent from a reformer, such as a fired tubular or non-tubular reformer) may be introduced in shell side inlet 104, passed through perforations in a distributor plate 123, and distributed to mix with the reacted fluid. The mixture of the reacted fluid and heating fluid may be configured to flow longitudinally through the tube bundle 116 for generally true countercurrent heat transfer (the logarithmic mean temperature difference correction factor may be essentially 1.0 within a 0.5-5% tolerance range) with the tubes 122. The mixture may then exit the tube bundle 116 from the open end of the flow sleeve 118, through the discharge annulus 120, and may be discharged through the shell side fluid outlet 106 for further processing in a conventional manner.

A tube-side inlet chamber 124 can be enclosed by a head 126 secured to the shell 108 by flange assembly 128, which may include a shell flange 402 and a head flange 403 (FIG. 4). The tubesheet 114 may be configured to serve as a partition to isolate fluid in the chamber 124 from fluid in the shell 108. In examples, the reforming exchanger 100 can include a heat-resistant refractory lining 130 affixed to the interior surfaces of the chamber 124 and shell 108. The refractory lining can be composed of ceramic or cement-like materials. In examples, the refractory lining may include one or more layers. In examples, ceramic and cement-like materials may include any suitable known material. In examples, the ceramics or cement-like materials may include one or more of alumina, silica, and/or iron. For example, the refractory lining 130 can have a high density inner layer 130-1 exposed to the interior of the shell 108 and/or chamber 124, and a backup or insulating layer 130-2 positioned between the inner layer and the respective inner surface of the shell 108 and/or chamber 124. This refractory can be assembled using conventional refractory anchors, cold seams, and mounting hardware generally used for this purpose in the art.

The operating temperatures for which the exchanger 100 may be designed can vary from approximately 400° C. to approximately 650° C. (752° F. and 1202° F.) for the components in the tube side chamber 124, and from approximately 650° C. to approximately 1050° C. (1202° F. and 1922° F.) for components in the shell 108. The exchanger 100 can generally withstand internal pressures up to pressures from approximately 2.4 MPa to approximately 6.9 MPa (350-1000 psi). These temperatures and pressures are only examples and are not limiting. A conventional water/steam jacket 132 can be used to monitor for generation of greater-than-normal amounts of steam which may indicate a potential “hot spot” or refractory failure.

The tube bundle 116 can made up of the tubes 122, one or more ring baffles 138 (also known as donut baffles, see FIG. 2), and one or more lattice support assemblies 140 (also known as rod or grid baffles). Each individual tube 122 can be expanded and/or stud welded on top of the tubesheet 114. The tubesheet 114 serves to support and position the tube bundle 116, as well as lattice support assemblies 140, baffles, and the distributor plate 123, in conjunction with a plurality of tie rods 125 which are threaded into the tubesheet 114 and extend to stabilize the support assemblies 140 and ring baffles 138 against spacer tubes 125-1 and washers 125-2, as shown in FIG. 2.

As shown in FIG. 2, the ring baffles 138 can be in the form of an annular plate that can be perforated to support the outermost tubes 122-1 of the individual tubes. The ring baffles 138 alternatively or additionally can have an inner contour to match a profile of outermost and/or penultimately outermost ones 22-2 of the tubes. The baffles 138 can have an outside diameter that, taking thermal expansion into account, matches an inside diameter of the refractory 130 (as shown in FIG. 1) to facilitate insertion and removal of the modular tube bundle 116. For example, at ambient temperatures the baffles 138 have sufficient clearance with the refractory 130 to allow the tube bundle 116 to be moved or slid in or out of engagement with the refractory, but at operating temperature the baffles 138 have an outside diameter that may be nearly equal to the inside diameter of the refractory 130 to inhibit fluid bypass around the outside of the tube bundle 116. The inner contour may define a circular or a generally circular flow window 142 for shell-side fluid to flow longitudinally through the tubes 122 within the flow window 142. The baffles 138 can facilitate turbulence and mixing in the shell side fluid to promote a more even shell-side fluid temperature and improve uniformity of heat transfer. As an example, 3 to 6 or more ring baffles 138 can be employed, but the number may be not critical and more or fewer can be used.

As shown in FIG. 1 and FIG. 3, the lattice support assemblies 140 can include first parallel lattice supports 144, and second parallel lattice supports 146 that are transverse to the first lateral supports 144. The lattice supports 144, 146 can be in the form of rectangular bars with a thickness corresponding to a spacing between the tubes 122 and length to span between opposite sides of a support ring 148. In the case of triangular pitch tubes 122, the first and second lattice supports 144, 146 can be oriented with an angular offset about 30 degrees from perpendicular with respect to each other (for example, with a large angle of about 120 degrees and a small angle of about 60 degrees).

The support ring 148 can be welded or otherwise secured to the ends of the lattice supports 144, 146. In one embodiment, the lattice supports 144, 146 are stacked longitudinally in abutment and the length or height of the support ring 148 corresponds to the total height of the lattice supports 144, 146. If desired, the support ring 148 and/or the lattice supports 146 (or alternatively or additionally lattice supports 144) can be secured to one of the baffles 138 for additional strength and to facilitate longitudinal positioning of the lattice support assembly 140 via tie rods 125.

The lattice support assembly 140 may serve to maintain spacing and pitch of the tubes 122. In examples, the lattice support assembly 140 may facilitate abatement of any vibration. In examples, the lattice support assembly 140 may promote turbulence and thermal mixing of the shell-side fluid as it passes between and around the lattice supports 144, and 146. In examples, this may facilitate a larger temperature differential at the surfaces of the tubes 122 and improve the overall rate and uniformity of the heat transfer.

The support ring 148 can have an outside diameter matching the inside diameter of the refractory 130 in the main part of the shell 108, taking any differential thermal expansion into account, to facilitate insertion and removal of the tube bundle 116, for example, in the hot or operating condition there can be a radial gap of about 3 mm (0.125 in.) between the support ring 148 and refractory 130. In examples, the support ring 148, in one or more of any lattice support assemblies 140 that are adjacent the discharge annulus 120, may have an outside diameter matching an inside diameter of the flow sleeve 118 for attachment thereto by welding or other conventional means. The flow sleeve 118 and support ring 148 can be made of the same material or, if different, materials with compatible thermal expansion coefficients. The flow sleeve 118 may be positioned on the tube bundle 116 so that the upper end may be evenly spaced from the tubesheet 114 and/or its refractory lining so as to define a radial slot for generally uniform passage of the shell-side fluid from the tube bundle 116 into the discharge annulus 120.

Referring again to FIG. 1, the flow sleeve 118 can be secured to an outwardly extending base ring 150 adjacent to a lower end opposite the tubesheet 114. The base ring 150 can have a surface opposite the discharge annulus 120. The base ring 150 may be disposed on a transverse annular sealing surface formed in an upper end of the refractory lining 130, for example, within the dense layer 130-1, to form a sealing engagement with the base ring 150. A lower flow seal 152 may be disposed between the base ring 150 and the annular sealing surface. In examples, the lower flow seal 152 may be made from a material that is designed for compression, e.g. from 24 mm to 12 mm. In examples, the lower flow seal may be made of spot-welded 28 BWG Alloy 601 or HR-235 sheet metal backing filled with 24 mm SAFFIL® 95% alumina low density mat.

The flow sleeve 118 may be configured to direct shell-side fluid longitudinally over the upper ends of the tubes 122. In examples, this may prevent short-circuiting of fluid to the shell-side outlet 106 which may otherwise result in uneven heat transfer with the tubes 122. As such, a perfect fluid-tight seal may not be necessary. In examples, some limited fluid leakage at the lower seal 152 can be tolerated.

As shown in FIGS. 1 and 4, the head 126 and tubesheet 114 may bolt to the shell 108. Referring to FIG. 4, the shell 108 may be configured with a welded steel anchor 416 that may be configured to cover the refractory materials 130-1 and 130-2 of the shell 108. In examples, the welded steel anchor 416 (also referred to herein as a “shell refractory latch”) may include a steel protrusion welded to the interior surface of the shell. Likewise, the tubesheet 114 may be configured with a steel latch assembly 420 (referred to herein also as a “tubesheet refractory latch”). In examples, a steel latch assembly 420 may be configured to surround the circumference of the tubesheet refractory 115.

In examples, during assembly of the reformer exchanger, a middle seal 405 may be disposed upon the tubesheet refractory 115 and the shell refractory latch 416 of the shell. The middle seal may include a heat resistant sealing material, such as thermal ceramic (e.g., a braided rope or sheet). Examples of materials for the middle seal 405 may include aluminum oxide and/or silicon dioxide. The tubesheet 114 and tubesheet refractory 115 can be disposed upon the middle seal 405 and then the tubesheet and middle seal may be pressed and sealed into the welded steel shell refractory latch 416 of the shell. Once so placed, the tubesheet 114 may be attached to the shell flange 402 using one or more fasteners, for example, bolts 409 that extend through bolt holes 417 provided in the tubesheet 114 and secure it within stair-shaped bolt knots 415 within the shell flange 402. This configuration for attaching the tubesheet 114 to the shell can maintain the middle seal 405 under constant or substantially constant bolted pressure via the bolting of the tubesheet to the shell flange 402.

Once the tubesheet 114 (and associated tube bundle 116, FIG. 1) is configured within the shell 108 as described above, the head 126 can be attached to the shell using fasteners, such as bolts. In examples, a top seal 406 and/or a gasket 419 may be disposed between the head and the shell. In examples, the top seal 406 may include a heat resistant sealing material, such as thermal ceramic (e.g., a braided robe or sheet). Examples of heat resistant sealing materials may include aluminum oxide and/or silicon dioxide. In examples, the gasket 419 may be made of a material such as graphite-covered metal. Example gaskets 419 include FLEXITALIC KAMMPROFILE or FLEXPRO. The head may be equipped with a welded steel latch 418 (also referred herein as a “head refractory latch”) that may be configured to cover the refractory materials 130-1 and 130-2 of the head. The head refractory latch may include a steel protrusion welded to an interior surface of the head. During assembly, the top seal 406 may be laid upon the tubesheet 114 and the gasket 419 may be laid upon the shell flange 402. Once the top seal and gasket are positioned, the head 126 may be placed upon the shell (and top seal and gasket). In examples, the head is equipped with a head flange (also referred to herein as channel flange) 403. The head may be attached by bolting the head flange 403 to the shell flange 402 via stud bolts 408. The head 126 may be placed upon the shell 108 such that the bolt holes 440-1 and 440-2 of the head and shell flanges are aligned and the flanges may then be joined with fasteners, such as stud bolts 408.

The disclosed reformer exchanger may provide a reliable and/or improved sealing configuration. This may improve and/or ensure integrity of the sealing between the head 126 and the shell 108. The top seal may provide a robust seal between the tubesheet 114 and the steel latch 418 of the head. The middle seal may provide a seal between the tubesheet refractory 115 and the steel latch 416 of the shell. Both the top seal 406 and the middle seal 405 are maintained under constant, or substantially constant, bolted pressure during operation. The top seal 406 may be maintained under bolted pressure due to the bolting of the head to the shell via the bolts 408. Likewise, the middle seal 405 may be maintained under bolted pressure via both the bolting of the tubesheet to the shell via bolts 409 and the bolting of the head to the shell via the bolts 408. This configuration may seal better and may be more impermeable to escape of hot gasses than sealing configurations included in various other reformer exchanger designs.

Unless defined otherwise, all technical and scientific terms used herein have the same meaning as is commonly understood by one of skill in the art to which the inventions belong. All patents, patent applications, published applications and publications, websites and other published materials referred to throughout the entire disclosure herein, unless noted otherwise, are incorporated by reference in their entirety. Where there is a plurality of definitions for terms herein, those in this section prevail. Where reference is made to a URL or other such identifier or address, it is understood that such identifiers can change and information on the internet can come and go, but equivalent information can be found by searching the internet. Reference thereto evidences the availability and public dissemination of such information.

As used herein, the singular forms “a”, “an” and “the” include plural referents unless the context clearly dictates otherwise.

The terms first, second, third, etc. as used herein can describe various elements, components, regions, layers and/or sections, these elements, components, regions, layers and/or sections should not be limited by these terms. These terms may be only used to distinguish one element, component, region, layer or section from another region, layer, or section. Terms such as “first”, “second”, and other numerical terms when used herein do not imply a sequence or order unless clearly indicated by the context. Thus, a first element, component, region, layer, or section discussed below could be termed a second element, component, region, layer, or section without departing from the teachings of the example embodiments.

As used herein, ranges and quantities can be expressed as “about” a particular value or range. “About” also includes the exact amount. Hence “about 5 percent” means about 5 percent in addition to 5 percent. The term “about” means within typical experimental error for the application or purpose intended.

As used herein, “and/or” includes any and all combinations of one or more of the associated listed items.

As used herein, a “combination” refers to any association between two items or among more than two items. The association can be spatial or refer to the use of the two or more items for a common purpose.

As used herein, “comprising” and “comprises” are to be interpreted to mean “including but not limited to” and “includes but not limited to”, respectively.

As used herein, “optional” or “optionally” means that the subsequently described event or circumstance does or does not occur, and that the description includes instances where the event or circumstance occurs and instances where it does not. For example, an optional component in a system means that the component may be present or may not be present in the system.

As used herein, “substantially” means “being largely but not wholly that which is specified.”

Although particular embodiments of the present invention have been shown and described, it should be understood that the above discussion may be not intended to limit the present invention to these embodiments. It will be obvious to those skilled in the art that various changes and modifications may be made without departing from the spirit and scope of the present invention. Thus, the present invention may be intended to cover alternatives, modifications, and equivalents that may fall within the spirit and scope of the present invention as defined by the claims.

What is claimed is:

1. A reforming exchanger reactor comprising:
a shell comprising a shell side fluid inlet configured to receive hot reformed gas;
a head comprising a tube side fluid inlet configured to receive a mixed gas feed;
a tube bundle comprising a plurality of tubes, wherein each of the tubes comprises:
an inlet end secured to a tubesheet configured to receive the mixed gas feed from the head; and
an outlet end adjacent to the shell side fluid inlet and configured to discharge catalytically reformed gas into the hot reformed gas to form a gas mixture; and
a shell side fluid outlet fluidly isolated from the tube side fluid inlet by the tube sheet and configured for discharging the gas mixture,
wherein the tube sheet is bolted to the shell, thereby disposing the tubes within the shell.

2. The reforming exchanger reactor of claim 1, the tubesheet is bolted directly to an interior of the shell.

3. The reforming exchanger reactor of claim 1, wherein:
the head comprises a head flange,
the shell comprises a shell flange, and
wherein the head flange is configured to bolt to the shell flange, thereby securing the head to the shell.

4. The reforming exchanger reactor of claim 3, wherein the shell comprises a shell refractory lining affixed to an interior surface of the shell and comprising one or more layers of refractory materials.

5. The reforming exchanger reactor of claim 4, further comprising a first seal configured between a portion of the shell flange and a portion of the tubesheet.

6. The reforming exchanger reactor of claim 5, wherein the tubesheet comprises a tubesheet refractory lining configured on a shell side surface of the tubesheet, and wherein the first seal is configured between the tubesheet refractory lining and the shell refractory lining.

7. The reforming exchanger reactor of claim 5, wherein the tubesheet comprises a tubesheet refractory lining configured on a shell side surface of the tubesheet, wherein the shell comprises a shell refractory latch affixed to an interior surface of the shell flange, and wherein the first seal is configured between the tubesheet refractory lining and the shell latch.

8. The reforming exchanger reactor of claim 5, wherein the first seal is maintained between the tubesheet and the shell flange under bolted pressure by the bolting of the tubesheet to the shell.

9. The reforming exchanger reactor of claim 4, wherein the head comprises a head refractory lining affixed to an interior surface of the head and comprising one or more layers of refractory materials.

10. The reforming exchanger reactor of claim 9, further comprising a second seal configured between a portion of the head and the tubesheet.

11. The reforming exchanger reactor of claim 10, wherein the second seal is configured between the head refractory lining and the tubesheet.

12. The reforming exchanger reactor of claim 10, wherein the head comprises a head refractory latch affixed to an interior surface of the head, and wherein the second seal is configured between the head refractory latch and the tubesheet.

13. The reforming exchanger reactor of claim 10, wherein the second seal is maintained between the tubesheet and the head under bolted pressure by the bolting of the head flange to the shell flange.

14. A method of assembling a reforming exchanger reactor, wherein the reforming exchanger reactor comprises a shell configured to receive hot reformed gas, a head comprising a tube side fluid inlet configured to receive a mixed gas feed, and a tube bundle comprising a tubesheet and plurality of tubes, the method comprising:
disposing a first seal upon a first portion of the shell;
bolting the tubesheet to the shell so that the plurality of tubes are within the shell and the first seal is secured between the tubesheet and the first portion of the shell;
disposing a second seal on a top portion of the tubesheet; and
bolting the head to the shell so that the second seal is secured between a portion of the head and the tubesheet.

15. The method of claim 14, wherein the first portion of the shell comprises a shell refractory latch affixed to an interior surface of the shell.

16. The method of claim 15, wherein the tubesheet comprises a tubesheet refractory lining configured on a shell side surface of the tubesheet, and wherein the first seal is secured between the tubesheet refractory lining and the shell refractory latch.

17. The method of claim 14, wherein the shell comprises a shell flange and the head comprises a head flange, and wherein bolting the head to the shell comprises bolting the shell flange to the head flange.

18. The method of claim 14, wherein the head comprises a head refractory latch affixed to an interior surface of the head and wherein the second seal is secured between the head refractory latch and a top surface of the tubesheet.
